(19) United States
(12) Patent Application Publication
(10) Pub. No.: US 2024/0087342 A1
(43) Pub. Date: Mar. 14, 2024

(54) IDENTIFICATION DEVICE AND IDENTIFICATION METHOD

(71) Applicant: Panasonic Intellectual Property Management Co., Ltd., Osaka (JP)

(72) Inventor: Shoichi ARAKI, Osaka (JP)

(21) Appl. No.: 18/509,744

(22) Filed: Nov. 15, 2023

Related U.S. Application Data
(63) Continuation of application No. PCT/JP2022/019900, filed on May 11, 2022.

(30) Foreign Application Priority Data
May 28, 2021 (JP) 2021-090395

(51) Int. Cl. G06V 20/60; G06T 7/90; G06V 10/12; G06V 10/56

(52) U.S. Cl. CPC G06V 20/60; G06T 7/90; G06V 10/12; G06V 10/56; G06T 2207/10024; G06T 2207/20081; G06T 2207/30184

(57) ABSTRACT

An identification device (10) includes a camera (12) that captures an image showing a target object, a distance measuring sensor (13) that measures the distance to the target object, and an information processor (16). The information processor (16) performs: a first identification process of identifying the color pattern of the target object by applying a first identification model to an image captured by the camera (12) while the distance measured by the distance measuring sensor (13) is within a first distance range; and a second identification process of identifying the color pattern of the target object by applying a second identification model different than the first identification model to an image captured by the camera (12) while the distance measured by the distance measuring sensor (13) is within a second distance range closer to the target object than the first distance range.

### CROSS REFERENCE TO RELATED APPLICATIONS

This is a continuation application of PCT International Application No. PCT/JP2022/019900 filed on May 11, 2022, designating the United States of America, which is based on and claims priority of Japanese Patent Application No. 2021-090395 filed on May 28, 2021. The entire disclosures of the above-identified applications, including the specifications, drawings, and claims are incorporated herein by reference in their entirety.

### FIELD

The present disclosure relates to identification devices and identification methods.

### BACKGROUND

A technique of using images obtained by capturing a target object in order to, for example, inspect the target object is known. In connection with such a technique, PTL 1 discloses an image matching device that compares and matches images based on methods such as template matching and pattern matching.

### CITATION LIST

### Patent Literature

PTL 1: Japanese Unexamined Patent Application Publication No. 2002-216131

### SUMMARY

### Technical Problem

The present disclosure provides an identification device and an identification method can identify the color pattern of a target object in an image depending on the distance to the target object at the time of capturing the image.

### Solution to Problem

An identification device according to one aspect of the present disclosure includes: a camera that captures an image showing a target object; a distance measuring sensor that measures a distance to the target object; and an information processor. The information processor performs: a first identification process of identifying a color pattern of the target object by applying a first identification model to an image captured by the camera while the distance measured by the distance measuring sensor is within a first distance range; and a second identification process of identifying a color pattern of the target object by applying a second identification model different than the first identification model to an image captured by the camera while the distance measured by the distance measuring sensor is within a second distance range closer to the target object than the first distance range.

An identification method according to one aspect of the present disclosure includes: identifying a color pattern of a target object by applying a first identification model to an image showing the target object captured by a camera while a distance to the target object measured by a distance measuring sensor is within a first distance range; and identifying a color pattern of the target object by applying a second identification model different than the first identification model to an image showing the target object captured by the camera while the distance to the target object measured by the distance measuring sensor is within a second distance range closer to the target object than the first distance range.

A recording medium according to one aspect of the present disclosure is a non-transitory computer-readable recording medium having recorded thereon a program for causing a computer to execute the above identification method.

### Advantageous Effects

The identification device and the identification method according to one aspect of the present disclosure can identify the color pattern of a target object in an image depending on the distance to the target object at the time of capturing the image.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is for illustrating an overview of an identification device according to one embodiment.

FIG. 2 is a block diagram illustrating the functional structure of the identification device according to one embodiment.

FIG. 3 illustrates first examples of capturing of images to be used as training data.

FIG. 4 illustrates second examples of capturing of images to be used as training data.

FIG. 5 is a flowchart of Operation Example 1 of the identification device according to one embodiment.

FIG. 6 illustrates one example of a display showing information instructing a user to capture an image from within a first distance range.

FIG. 7 illustrates an example of set identification regions.

FIG. 8 illustrates one example of classification scores.

FIG. 9 illustrates one example of a display showing information instructing a user to capture an image from within a second distance range.

FIG. 10 is a flowchart of Operation Example 2 of the identification device according to one embodiment.

### DESCRIPTION OF EMBODIMENT(S)

### Underlying Knowledge Forming Basis of Present Disclosure

A technique of capturing an image showing a target object and identifying the target object is known. In such a technique, there are cases where a special camera, such as a probe, is pressed against the target object to capture the image.

In contrast, the present disclosure provides, for example, an identification device with improved usability that can identify the color pattern of a target object in an image based on an image taken at a relatively distant position from the target object, using a distance measuring sensor, a camera, and a light source included in a general-purpose portable terminal such as a tablet terminal or a smartphone.

An identification device according to one aspect of the present disclosure includes: a camera that captures an image showing a target object; a distance measuring sensor that measures a distance to the target object; and an information processor. The information processor performs: a first identification process of identifying a color pattern of the target object by applying a first identification model to an image captured by the camera while the distance measured by the distance measuring sensor is within a first distance range; and a second identification process of identifying a color pattern of the target object by applying a second identification model different than the first identification model to an image captured by the camera while the distance measured by the distance measuring sensor is within a second distance range closer to the target object than the first distance range.

For example, the identification device further includes a display. For example, the information processor: determines whether a score indicating a likelihood of an identification result of the first identification process is greater than or equal to a predetermined value; and when the score is less than the predetermined value, displays information instructing capturing of an image from within the second distance range on the display.

For example, the information processor: displays, before the first identification process, information instructing capturing of an image from within the first distance range on the display; and displays, at a point in time that is after the first identification process and before the second identification process, information instructing capturing of an image from within the second distance range on the display.

For example, the identification device further includes a display. For example, the information processor: displays, on the display, information instructing capturing of an image from within a predetermined distance range that merges the first distance range and the second distance range; performs the first identification process conditional to determining that the image captured by the camera after displaying the information has been captured while the distance measured by the distance measuring sensor is within the first distance range; and performs the second identification process conditional to determining that the image captured by the camera after displaying the information has been captured while the distance measured by the distance measuring sensor is within the second distance range.

For example, the camera: in the first identification process, automatically captures the image when the distance measured by the distance measuring sensor enters the first distance range from outside the first distance range; and in the second identification process, automatically captures the image when the distance measured by the distance measuring sensor enters the second distance range from outside the second distance range.

For example, the identification device further includes a light source that illuminates the target object when the camera captures the image.

For example, the target object is an interior material installed in a building.

An identification method according to one aspect of the present disclosure includes: identifying a color pattern of a target object by applying a first identification model to an image showing the target object captured by a camera while a distance to the target object measured by a distance measuring sensor is within a first distance range; and identifying a color pattern of the target object by applying a second identification model different than the first identification model to an image showing the target object captured by the camera while the distance to the target object measured by the distance measuring sensor is within a second distance range closer to the target object than the first distance range.

A recording medium according to one aspect of the present disclosure is a non-transitory computer-readable recording medium having recorded thereon a program for causing a computer to execute the above identification method.

Hereinafter, embodiments of the present disclosure will be described with reference to the figures. Each of the embodiments described below is a general or specific example. The numerical values, shapes, materials, elements, arrangement and connection of the elements, steps, order of the steps, etc., indicated in the following embodiments are mere examples and are not intended to limit the present disclosure. Therefore, among elements in the following embodiments, those not recited in any one of the independent claims are described as optional elements.

The figures are schematic diagrams and are not necessarily precise depictions. In the figures, elements having essentially the same configuration share like reference signs, and duplicate description may be omitted or simplified.

### Embodiment

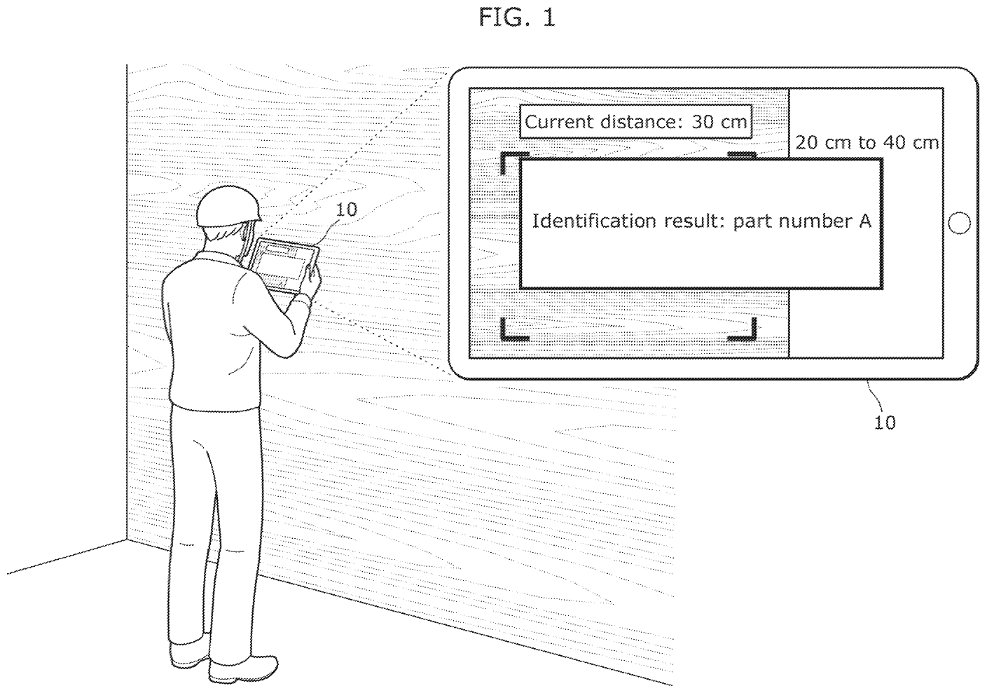

Overview First, an overview of the identification device according to one embodiment will be described. FIG. 1 is for illustrating an overview of an identification device according to one embodiment.

As illustrated in FIG. 1, identification device 10 according to one embodiment is realized as, for example, a tablet terminal, and is used by a user who inspects interior materials. As used herein, inspection of interior materials refers to inspection of whether the correct interior material according to specification has been installed.

For example, in the sale of new condominiums, many choices for interior materials such as flooring and wallpaper are offered to accommodate various customer preferences. It is therefore necessary to inspect whether the interior materials specified by the customer have been installed correctly before handing over the residence to the customer. Identification device 10 is used to inspect such interior materials.

Note that interior materials is a generic term for finishing and base materials used for, but not limited to floors, walls, ceilings, and fixtures. Interior materials include not only finishing materials such as flooring, carpets, tiles, wallpaper, plywood, and painted materials that are directly visible the room, but also the underlying base materials.

When identification device 10 obtains, via user operation, an image of a part to which an interior material is attached through user operation, it can identify the part number of the interior material in the image and store (record) the identification result.

Configuration

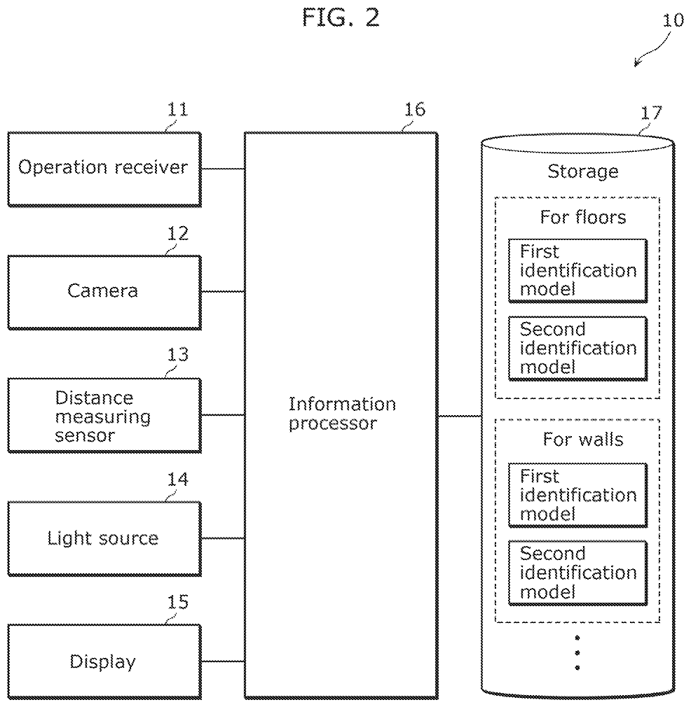

Hereinafter, the configuration of such an identification device 10 will be described. FIG. 2 is a block diagram illustrating the functional structure of identification device 10.

As illustrated in FIG. 2, identification device 10 includes operation receiver 11, camera 12, distance measuring sensor 13, light source 14, display 15, information processor 16, and storage 17.

Identification device 10 is realized, for example, by installing a specialized application program on a general-purpose portable terminal such as a tablet terminal. Identification device 10 may be a dedicated device.

Operation receiver 11 accepts user operations. Operation receiver 11 is realized by a touch panel and one or more hardware buttons, for example.

Camera 12 captures an image when operation receiver 11 receives an operation instructing such. Camera 12 is realized, for example, by a complementary metal-oxide semiconductor (CMOS) image sensor. Images obtained by camera 12 are stored in storage 17.

Distance measuring sensor 13 measures the distance from identification device 10 to a target object (in the present embodiment, the interior material attached to a part in a building). Distance measuring sensor 13 is realized, for example, as a time-of-flight (ToF) light detection and ranging (LiDAR) sensor, but may also be realized by other sensors such as an ultrasonic distance sensor. Distance measuring sensor 13 may be a sensor built into the general-purpose portable terminal, and, alternatively, may be an external sensor connected to the general-purpose portable terminal.

Light source 14 shines light on the target object as camera 12 captures images. Light source 14 is realized by a light-emitting element such as a light-emitting diode (LED), and emits white light. Light source 14 may emit light continuously for a certain period of time as camera 12 captures images, or it may emit light instantaneously in response to an operation instructing capturing of an image.

Display 15 displays a display screen based on control by information processor 16. Display 15 includes, for example, a liquid crystal panel or an organic electroluminescent (EL) panel as a display device.

Information processor 16 performs information processing related to identifying the part number of the interior material attached to the part shown in the image captured by camera 12. Information processor 16 is realized by, for example, a microcomputer, but may be realized by a processor. The functions of information processor 16 are realized by the microcomputer or processor embodying information processor 16 executing a program stored in storage 17.

Storage 17 is a storage device that stores the program that information processor 16 executes to perform the above information processing as well as information necessary for the information processing. Storage 17 is realized, for example, by semiconductor memory.

### Identification Model

Storage 17 stores, for each part of a room such as the floor, a wall, the ceiling, or a fixture, a first identification model and a second identification model for identifying the interior material attached to the part.

The first identification model is a machine learning model that uses images captured a first distance away from target parts as training data, is configured to be able to identify the part number of an interior material, and is stored in storage 17 in advance.

Specifically, the first identification model outputs a classification score based on machine learning, such as a convolutional neural network (CNN). The classification score is a score that indicates which part number the interior material attached to the target part is more likely to be, for example, part number A: 0.60, part number B: 0.20, and so on.

The second identification model is a machine learning model that uses images captured a second distance away from target parts as training data, is configured to be able to identify the part number of an interior material, and is stored in storage 17 in advance. The second distance is shorter than the first distance. Specifically, the second identification model outputs a classification score based on machine learning, such as a convolutional neural network.

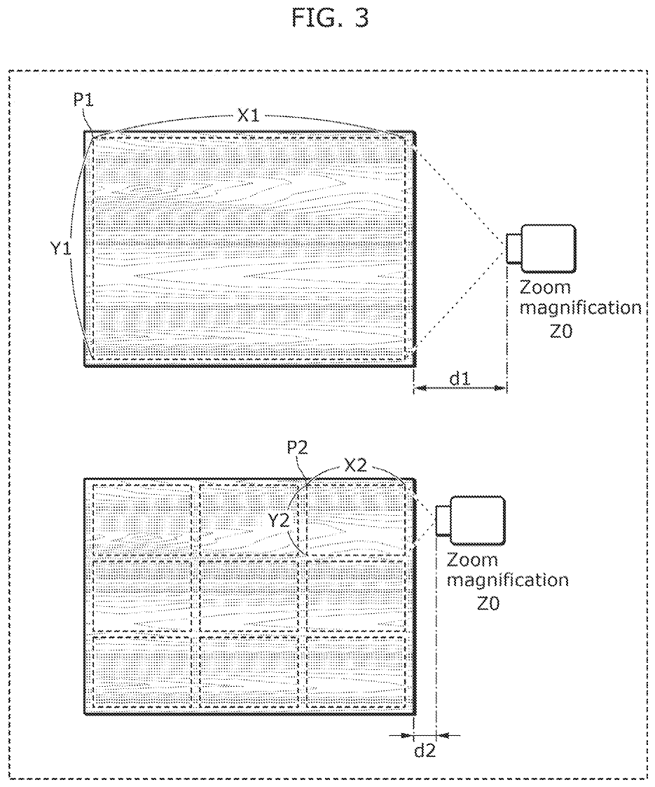

Hereinafter, example of images used as training data in machine learning for constructing the first identification model and the second identification model will be described. FIG. 3 illustrates examples of capturing of images to be used as training data. The images used as training data are labeled with identification information of the interior materials in the images. The identification information of an interior material is, for example, the part number of the interior material, but it may be the product name of the interior material. In the drawings, the color pattern of the interior material is shown as a wood grain pattern (illustrated with dashed lines in, for example, FIG. 3), but the color pattern of the interior material is not particular limited.

In the example in FIG. 3, image P1 for the first identification model is captured from a distance of first distance d1 (for example, 30 cm). Image P1, for example, is an image with a resolution of 1312×984 pixels, showing a region whose actual size is X1=30 cm and Y1=21 cm. Image P2 for the second identification model is captured from a distance of second distance d2 (for example, 10 cm) at the same zoom magnification Z0 used when capturing image P1. Image P2, for example, is an image with the same resolution as image P1 (for example, 1312×984 pixels), showing a region whose actual size is X2=10 cm and Y2=7 cm. Stated differently, in the example in FIG. 3, image P1 and image P2 have the same resolution (number of pixels) but different pixel resolutions.

Note that to account for errors, for example, a plurality of images captured while changing first distance d1 between 20 cm and 40 cm are used as image P1 for the first identification model. Similarly, to account for errors, for example, a plurality of images captured while changing second distance d2 between 6 cm and 14 cm are used as image P2 for the second identification model.

To construct the first identification model, a plurality of images P1 characterized by different shooting conditions, such as the lighting conditions at the time of shooting and first distance d1, for a single interior material, are used as training data. Similarly, to construct the second identification model, a plurality of images P2 characterized by different shooting conditions, such as the lighting conditions at the time of shooting and second distance d2, for a single interior material, are used as training data.

Thus, storage 17 stores a first identification model suitable for identifying images captured from a distance of first distance d1 and a second identification model suitable for identifying images captured from a distance of second distance d2. As described below, identification device 10 improves identification accuracy by switching the identification model to be applied according to the distance from the target part to identification device 10 at the time of capturing the image.

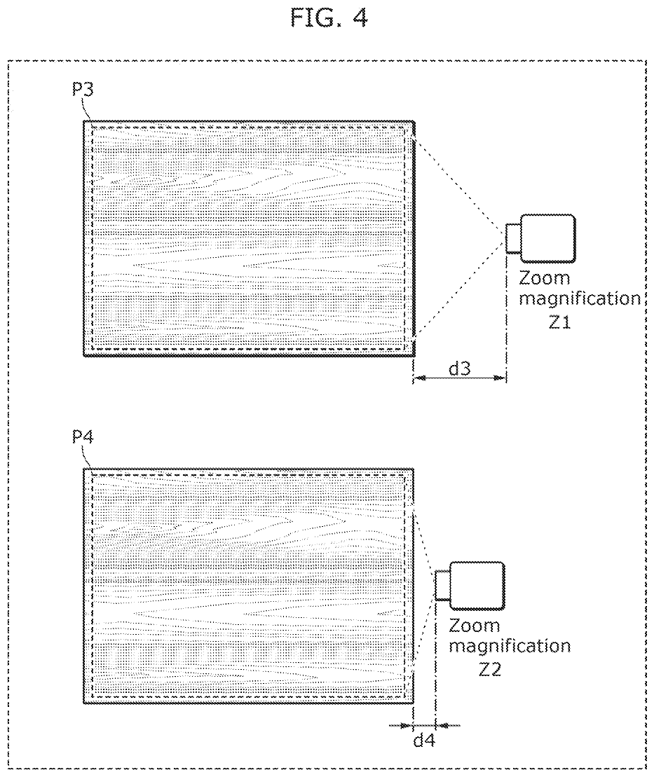

By changing the capturing distance and zoom magnification, images with different lighting conditions and the same pixel resolution can be captured, and such images can be used as training data. FIG. 4 is for illustrating such an image capturing example.

In the example in FIG. 4, image P3 is an image captured from a distance of d3 (for example, 50 cm) at zoom magnification Z1 (for example, 1.0×). Image P4 is an image of a region the same size as that of image P3, captured from a distance of d4 (for example, 30 cm) at zoom magnification Z2 (for example, 1.6×). Images P3 and P4 are images with the same resolution, for example, a resolution of 4032×3064 pixels, but may have a resolution of at least approximately 1000×1000 pixels (for example, 1312×984 pixels). Stated differently, in the example in FIG. 4, images P3 and P4 have the same resolution and the same pixel resolution.

### Operation Example 1

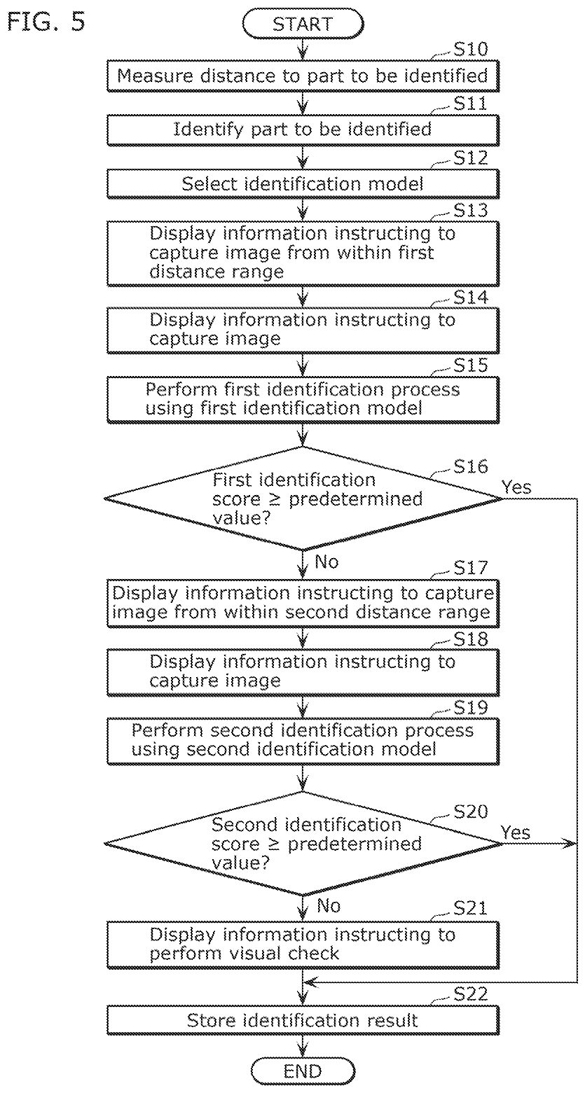

By switching between the first and second identification models, identification device 10 can assist the user in efficiently inspecting interior materials. Hereinafter, Operation Example 1 of such an identification device 10 will be described. FIG. 5 is a flowchart of Operation Example 1 of identification device 10.

First, distance measuring sensor 13 of identification device 10 measures the distance between identification device 10 and the part to be identified (hereinafter simply described as the target part) (S10). During subsequent processes, the distance from identification device 10 to the target part is measured in real time by distance measuring sensor 13. Next, information processor 16 identifies the target part (S11). For example, information processor 16 uses the distance measured by distance measuring sensor 13 and image information captured by camera 12 to recognize a plane corresponding to any of the floor, a wall, the ceiling, and a fixture of the room the user is in, and uses features of the image captured by camera 12 to identify which part, i.e., the floor, a wall, the ceiling, or a fixture, the plane being captured is. When identifying a target part from image features, for example, an identification model constructed to identify parts from image features is used. Note that the target part may be specified manually by the user, in which case information processor 16 identifies the target part based on an operation by the user of specifying the part as received by operation receiver 11.

Next, information processor 16 selects an identification model based on the identified target part (S12). As described above, a pair of the first and second identification models is stored in storage 17 per part, and information processor 16 selects the pair of the first and second identification models for the part identified in step S11.

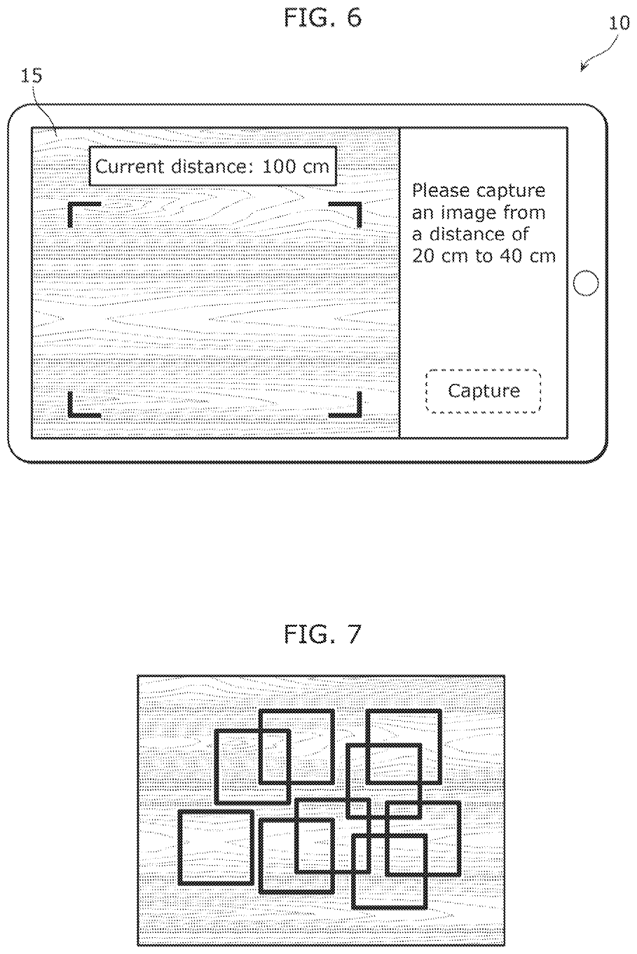

Next, information processor 16 displays, on display 15, the current distance to the target part and information instructing the user to capture an image from within a first distance range (S13). FIG. 6 illustrates one example of display 15 showing information instructing the user to capture an image from within the first distance range. When the first distance from the target part to identification device 10 is d1, the first distance range is d1±a predetermined distance. For example, the first distance range is 30±10 (cm).

When the user moves and the distance to the target part measured by distance measuring sensor 13 enters the first distance range, information processor 16 displays information for camera 12 to capture an image showing the target part on display 15 (S14). For example, information processor 16 displays, on display 15, an operation button that the user operates to capture an image, and causes camera 12 to capture an image showing the target part based on the user tapping the capture button displayed on display 15. When capturing an image, information processor 16 illuminates the target part by emitting light from light source 14.

The operation of the capture button is valid, for example, when the distance to the target part measured by distance measuring sensor 13 is within the first distance range. When the distance to the target part measured by distance measuring sensor 13 is outside the first distance range, the operation of the capture button is invalid. Therefore, in step S14, the image is captured under the condition that the distance from identification device 10 to the target part is within the first distance range.

Note that images are not required be captured based on user operation. For example, an image may be automatically captured when the distance to the target part measured by distance measuring sensor 13 enters the first distance range from outside the first distance range.

Next, information processor 16 performs a first identification process of identifying the interior material attached to the target part (the color pattern of the target part) by applying the first identification model selected in step S12 to the image captured in step S14 (S15). Specifically, information processor 16 sets, for example, a plurality of identification regions in the image captured in step S14. An identification region corresponds to a portion of the image, and may overlap with other identification regions. FIG. 7 illustrates an example of set identification regions. In FIG. 7, each of the nine rectangular regions in the single image is an identification region. For example, the nine identification regions are set randomly. Note that the number of identification regions given here is merely one example.

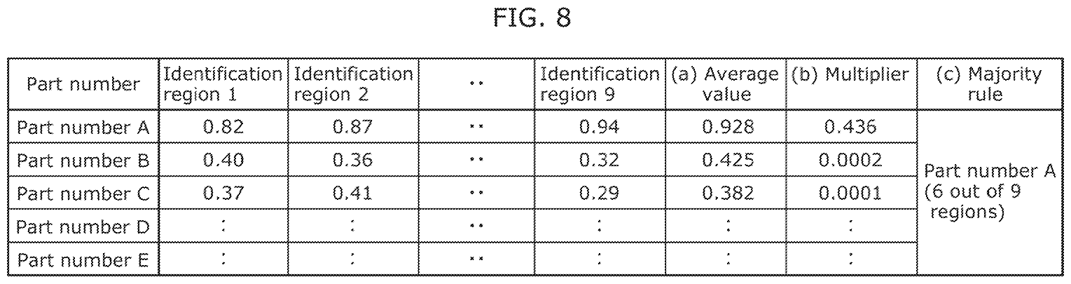

Information processor 16 identifies a classification score for each of the nine identification regions by inputting each of the nine identification regions into the first identification model. FIG. 8 illustrates one example of identified classification scores. Corresponding to the images used as training data described above, one identification region has a resolution of 1312×984 pixels.

Information processor 16 determines a first identification score based on the classification scores of the nine identification regions. The first identification score is a score indicating the likelihood (in other words, the validity or certainty) of the identification result of the first identification process, and is expressed from 0 through 1, where the higher the value, the higher the likelihood. For example, as illustrated in the column “(a) average value” in FIG. 8, information processor 16 determines the highest score among the average values of the classification scores of a predetermined number of interior material part numbers (five in the example in FIG. 8) to be the first identification score.

Note that information processor 16 may determine the highest score among the multipliers of the classification scores of a predetermined number of interior material part numbers to be the first identification score, as illustrated in the column “(b) multiplier” in FIG. 8. Furthermore, information processor 16 may identify the part number with the highest classification score for each of the nine identification regions, aggregate the identified part numbers, and determine the frequency of the most frequent part number (n of the 9 target regions) to be the first identification score, as illustrated in the column “(c) majority rule” in FIG. 8.

Next, information processor 16 determines whether the first identification score determined in step S15 is greater than or equal to a predetermined value (S16). If information processor 16 determines that the first identification score is greater than or equal to the predetermined value (Yes in S16), information processor 16 assumes that the interior material attached to the target part has been identified with a high likelihood and stores information associating the identification information of the target part and the part number of the interior material corresponding to the first identification score in storage 17 as the identification result (S22).

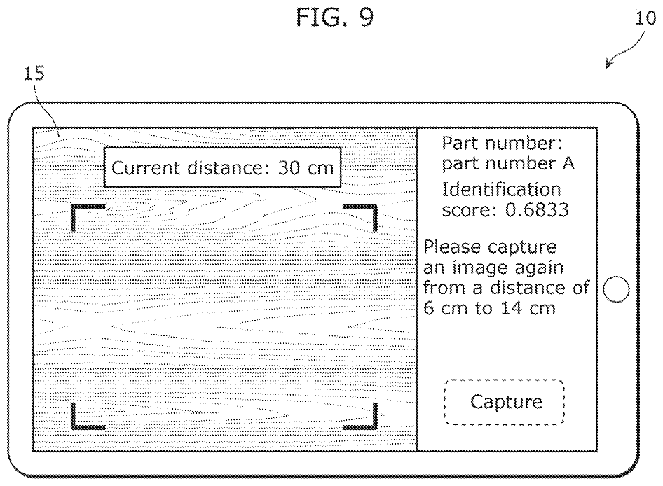

However, if information processor 16 determines that the first identification score is less than the predetermined value (No in S16), information processor 16 assumes that the likelihood is insufficient and tries the identification process again with identification device 10 closer to the target part. More specifically, information processor 16 displays information on display 15 instructing the user to capture an image from within a second distance range closer to the target part than the first distance range (S17). FIG. 9 illustrates one example of display 15 showing information instructing the user to capture an image from within the second distance range. When the second distance from the target part to identification device 10 is d2, the second distance range is d2±a predetermined distance. For example, the second distance range is 10±4 (cm), but may be 10±8 (cm). The second distance range may be an asymmetric range with respect to second distance d2, for example, a range of 8 cm to 18 cm when second distance d2 is 10 cm.

When the user moves and the distance to the target part measured by distance measuring sensor 13 enters the second distance range, information processor 16 displays information for camera 12 to capture an image showing the target part on display 15 (S18). The process in step S18 is the same as the process in step S14.

Next, information processor 16 performs a second identification process of identifying the interior material attached to the target part (the color pattern of the target part) by applying the second identification model selected in step S12 to the image captured in step S18 (S19). The process in step S19 is the same as the process in step S15, except that the second identification model is applied.

Next, information processor 16 determines whether the second identification score determined in step S19 is greater than or equal to a predetermined value (S20). If information processor 16 determines that the second identification score is greater than or equal to the predetermined value (Yes in S20), information processor 16 assumes that the interior material attached to the target part has been identified with a high likelihood and stores information associating the identification information of the target part and the part number of the interior material corresponding to the second identification score in storage 17 as the identification result (S22).

However, if information processor 16 determines that the second identification score is less than the predetermined value (No in S20), information processor 16 assumes that the likelihood is insufficient and displays information on display 15 instructing the user to visually check the part number of the interior material attached to the target part (S21). Information processor 16 stores, in storage 17 as the identification result, information that associates the part number of the interior material as checked and entered based on the user operating operation receiver 11 with the identification information of the target part (S22). In step S21, information instructing the user to perform the identification process again (i.e., to redo the image capture) may be displayed on display 15 instead of information instructing the user to visually check the part number.

As described above, in the first identification process, identification device 10 determines whether the first identification score is greater than or equal to a predetermined value, and if the first identification score is determined to be less than the predetermined value, performs the second identification process. In general, it is better to capture images for identification purposes in close proximity to the target part in order to reduce the influence of, for example, ambient light, but in order to capture images in close proximity, the user needs to move closer to the target part. Stated differently, having to move closer and capture and image is time-consuming for the user.

In contrast, with identification device 10, the user captures an image in close proximity to the target object only when the likelihood of the identification result based on an image captured at a distance farther from the target part than close proximity is low. Stated differently, the user does not need to always be in close proximity to the target object to capture images. Identification device 10 can be said to be an identification device with improved usability that can assist users in efficiently inspecting interior materials.

### Operation Example 2

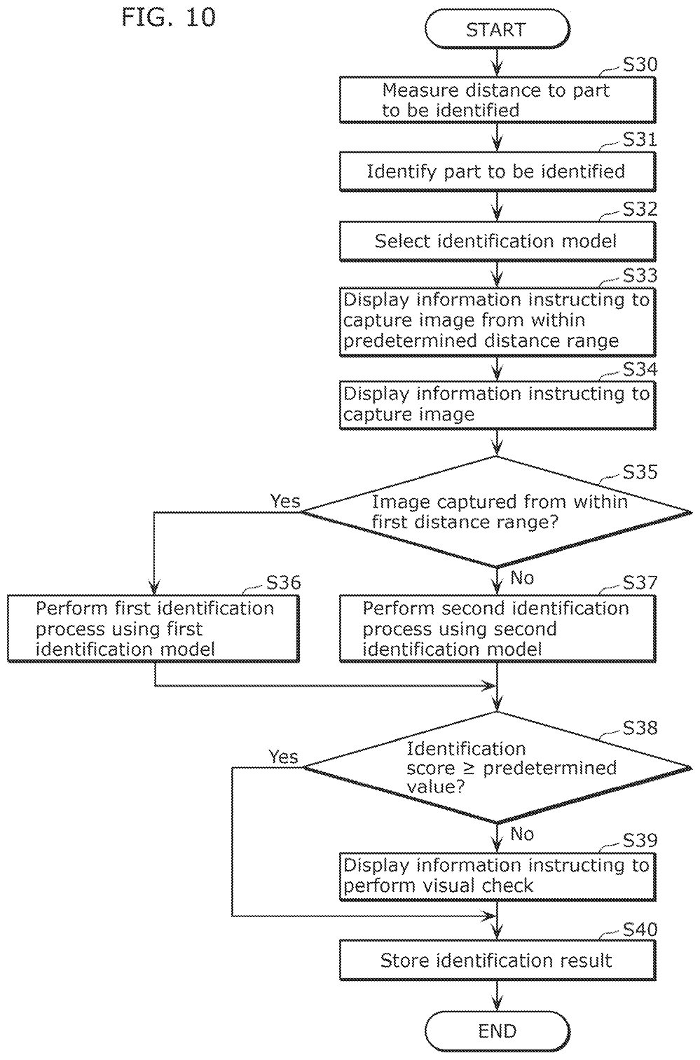

Next, Operation Example 2 of identification device 10 will be described. FIG. 10 is a flowchart of Operation Example 2 of identification device 10.

First, distance measuring sensor 13 of identification device 10 measures the distance between identification device 10 and the target part (S30). Next, information processor 16 identifies the target part (S31), and selects an identification model based on the identified target part (S32). The processes in steps S30 to S32 are the same as the processes in steps S10 to S12.

Next, information processor 16 displays information instructing the user to capture an image from within a predetermined distance range on display 15 (S33). Here, the predetermined distance range is the combined distance range of the first distance range and the second distance range.

When the user moves and the distance to the target part measured by distance measuring sensor 13 enters the distance range that merges the first distance range and the second distance range, information processor 16 displays information for camera 12 to capture an image showing the target part on display 15 (S34). For example, an operation button that the user operates to capture an image is displayed on display 15, and information processor 16 causes camera 12 to capture an image showing the target part based on the user tapping the capture button displayed on display 15. When capturing an image, information processor 16 illuminates the target part by emitting light from light source 14.

The operation of the capture button is valid, for example, when the distance to the target part measured by distance measuring sensor 13 is within only the predetermined distance range. When the distance to the target part measured by distance measuring sensor 13 is outside the predetermined distance range, the operation of the capture button is invalid. Therefore, in step S34, the image is captured under the condition that the distance from identification device 10 to the target part is within the predetermined distance range.

Note that images are not required be captured based on user operation. For example, an image may be automatically captured when the distance to the target part measured by distance measuring sensor 13 enters the predetermined distance range from outside the predetermined distance range.

Next, information processor 16 determines whether the distance at which the image was captured is within the first distance range (within the second distance range) (S35). When information processor 16 determines that the distance at which the image was captured is within the first distance range (Yes in S35), information processor 16 performs a first identification process of identifying the interior material attached to the target part (the color pattern of the target part) by applying the first identification model selected in step S32 to the image captured in step S34 (S36). The process in step S36 is the same as the process in step S15.

However, when information processor 16 determines that the distance at which the image was captured is within the second distance range (No in S35), information processor 16 performs a second identification process of identifying the interior material attached to the target part (the color pattern of the target part) by applying the second identification model selected in step S32 to the image captured in step S34 (S37). The process in step S37 is the same as the process in step S19.

Next, information processor 16 determines whether the first or second identification score determined in step S36 or S37 is greater than or equal to a predetermined value (S38). If information processor 16 determines that the first or second identification score is greater than or equal to the predetermined value (Yes in S38), information processor 16 assumes that the interior material attached to the target part has been identified with a high likelihood and stores information associating the identification information of the target part and the part number of the interior material corresponding to the first or second identification score in storage 17 as the identification result (S40).

However, if information processor 16 determines that the first or second identification score is less than the predetermined value (No in S38), information processor 16 assumes that the likelihood is insufficient and displays information on display 15 instructing the user to visually check the part number of the interior material attached to the target part (S39). Information processor 16 stores, in storage 17 as the identification result, information that associates the part number of the interior material as checked and entered based on the user operating operation receiver 11 with the identification information of the target part (S40). In step S39, information instructing the user to perform the identification process again (i.e., to redo the image capture) may be displayed on display 15 instead of information instructing the user to visually check the part number.

As described above, identification device 10 switches between the first and second identification processes depending on the distance at which the image was captured. This allows the user to choose, depending on the situation, whether to capture the image at close proximity or at a distance farther from the target part than close proximity. Identification device 10 can be said to be an identification device with improved usability that can assist users in efficiently inspecting interior materials.

### Variations

In the above embodiment, the part number of an interior material whose first or second identification score is greater than or equal to a predetermined value is recognized, but the part number of an interior material whose first and second identification scores are both greater than or equal to a predetermined value may be recognized.

In the above embodiment, Operation Example 1 and Operation Example 2 may be arbitrarily combined. For example, identification device 10 may selectively execute a first mode which performs Operation Example 1 or a second mode which performs Operation Example 2 according to, for example, a user operation.

In the above embodiment, identification device 10 identifies the part number of an interior material (one example of a target object) while attached to a target part from among a plurality of parts of a building. However, identification device 10 can identify the pattern of interior materials, and can also identify the color pattern of target objects other than interior materials.

### Advantageous Effects

As described above, identification device 10 includes camera 12 that captures an image showing a target object, distance measuring sensor 13 that measures the distance to the target object, and information processor 16. Information processor 16 performs: a first identification process of identifying the color pattern of the target object by applying a first identification model to an image captured by camera 12 while the distance measured by distance measuring sensor 13 is within a first distance range; and a second identification process of identifying the color pattern of the target object by applying a second identification model different than the first identification model to an image captured by camera 12 while the distance measured by distance measuring sensor 13 is within a second distance range closer to the target object than the first distance range.

Such an identification device 10 can identify the color pattern of a target object in an image depending on the distance to the target object at the time of capturing the image.

For example, identification device 10 further includes display 15. For example, information processor 16: determines whether a score indicating a likelihood of an identification result of the first identification process is greater than or equal to a predetermined value; and when the score is less than the predetermined value, displays information instructing capturing of an image from within the second distance range on display 15.

Such an identification device 10 can guide the user to perform the second identification process when the likelihood of the identification result based on the first identification process is low.

For example, information processor 16: displays, before the first identification process, information instructing capturing of an image from within the first distance range on display 15; and displays, at a point in time that is after the first identification process and before the second identification process, information instructing capturing of an image from within the second distance range on display 15.

Such an identification device 10 can guide the user so as to perform the first identification process first and then the second identification process second.

For example, identification device 10 further includes display 15. For example, information processor 16 displays, on display 15, information instructing capturing of an image from within a predetermined distance range that merges the first distance range and the second distance range. For example, information processor 16 performs the first identification process conditional to determining that the image captured by camera 12 after displaying the information has been captured while the distance measured by distance measuring sensor 13 is within the first distance range. For example, information processor 16 performs the second identification process conditional to determining that the image captured by camera 12 after displaying the information has been captured while the distance measured by distance measuring sensor 13 is within the second distance range.

Such an identification device 10 can switch between the first and second identification processes depending on the distance from identification device 10 to the target object at the time of capturing the image.

For example, in the first identification process, camera 12 automatically captures the image when the distance measured by distance measuring sensor 13 enters the first distance range from outside the first distance range. For example, in the second identification process, camera 12 automatically captures the image when the distance measured by distance measuring sensor 13 enters the second distance range from outside the second distance range.

Such an identification device 10 can omit the user operation (i.e., the user tapping the capture button) to capture an image.

For example, identification device 10 further includes light source 14 that illuminates the target object when camera 12 captures the image.

Such an identification device 10 can reduce the influence of ambient light when capturing images.

For example, the target object is an interior material installed in a building.

Such an identification device 10 can identify the color pattern of an interior material installed in a building.

An identification method executed by a computer such as identification device 10 includes: identifying a color pattern of a target object by applying a first identification model to an image showing the target object captured by camera 12 while a distance to the target object measured by distance measuring sensor 13 is within a first distance range; and identifying a color pattern of the target object by applying a second identification model different than the first identification model to an image showing the target object captured by camera 12 while the distance to the target object measured by distance measuring sensor 13 is within a second distance range closer to the target object than the first distance range.

Such an identification method can identify the color pattern of a target object in an image depending on the distance to the target object at the time of capturing the image.

### Other Embodiments

Although the present disclosure has been described based an embodiment, the present disclosure is not limited to the above embodiment.

For example, the present disclosure may be realized as a client-server system in which the functions of the identification device according to the above embodiment are allocated to client and server devices. In such cases, the client device is a portable terminal that captures images, accepts user operations, and displays identification results, while the server device is an information terminal that performs the first and second identification processes using images. The identification device may also be a robotic device that moves within the building or a drone device that flies within the building. In such cases, at least some of the user's operations are not required.

In the above embodiment, processes performed by a particular processor may be performed by a different processor. Moreover, the processing order of the processes may be changed, and the processes may be performed in parallel.

In the above embodiment, each element may be realized by executing a software program suitable for the element. Each element may be realized by means of a program executing unit, such as a central processing unit (CPU) or a processor, reading and executing a software program recorded on a recording medium such as a hard disk or semiconductor memory.

Each element may be realized by hardware. Each element may be a circuit (or integrated circuit). These circuits may be collectively configured as a single circuit and, alternatively, may be individual circuits. Moreover, these circuits may be general-purpose circuits or specialized circuits.

General or specific aspects of the present disclosure may be realized as a system, a device, a method, an integrated circuit, a computer program, or computer-readable recording medium, such as a CD-ROM, or any combination thereof.

For example, the present disclosure may be realized as an identification method executed by a computer such as an identification device. The present disclosure may be realized as a program for causing a computer to execute such an identification method (i.e., a program for causing a general-purpose portable terminal to operate as the identification device according to the above embodiment). The present disclosure may be realized as a computer-readable non-transitory recording medium having recorded thereon such a program.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The present disclosure is applicable as an identification device that can identify the color pattern of a target object in an image depending on the distance to the target object at the time of capturing the image.

1. An identification device comprising:
a camera that captures an image showing a target object;
a distance measuring sensor that measures a distance to the target object; and
an information processor, wherein
the information processor performs:
a first identification process of identifying a color pattern of the target object by applying a first identification model to an image captured by the camera while the distance measured by the distance measuring sensor is within a first distance range; and
a second identification process of identifying a color pattern of the target object by applying a second identification model different than the first identification model to an image captured by the camera while the distance measured by the distance measuring sensor is within a second distance range closer to the target object than the first distance range.

2. The identification device according to claim 1, further comprising:
a display, wherein
the information processor:
determines whether a score indicating a likelihood of an identification result of the first identification process is greater than or equal to a predetermined value; and
when the score is less than the predetermined value, displays information instructing capturing of an image from within the second distance range on the display.

3. The identification device according to claim 2, wherein
the information processor:
displays, before the first identification process, information instructing capturing of an image from within the first distance range on the display; and
displays, at a point in time that is after the first identification process and before the second identification process, information instructing capturing of an image from within the second distance range on the display.

4. The identification device according to claim 1, further comprising:
a display, wherein
the information processor:
displays, on the display, information instructing capturing of an image from within a predetermined distance range that merges the first distance range and the second distance range;
performs the first identification process conditional to determining that the image captured by the camera after displaying the information has been captured while the distance measured by the distance measuring sensor is within the first distance range; and
performs the second identification process conditional to determining that the image captured by the camera after displaying the information has been captured while the distance measured by the distance measuring sensor is within the second distance range.

5. The identification device according to claim 1, wherein
the camera:
in the first identification process, automatically captures the image when the distance measured by the distance measuring sensor enters the first distance range from outside the first distance range; and
in the second identification process, automatically captures the image when the distance measured by the distance measuring sensor enters the second distance range from outside the second distance range.

6. The identification device according to claim 1, further comprising:
a light source that illuminates the target object when the camera captures the image.

7. The identification device according to claim 1, wherein
the target object is an interior material installed in a building.

8. An identification method comprising:
identifying a color pattern of a target object by applying a first identification model to an image showing the target object captured by a camera while a distance to the target object measured by a distance measuring sensor is within a first distance range; and
identifying a color pattern of the target object by applying a second identification model different than the first identification model to an image showing the target object captured by the camera while the distance to the target object measured by the distance measuring sensor is within a second distance range closer to the target object than the first distance range.

9. A non-transitory computer-readable recording medium having recorded thereon a program for causing a computer to execute the identification method according to claim 8.
